(19) United States
(12) Patent Application Publication
(10) Pub. No.: US 2012/0121252 A1
(43) Pub. Date: May 17, 2012

(54) OPTICAL COMMUNICATION SYSTEM FOR SUPPORTING REMOTE OPERATION MANAGEMENT

(75) Inventors: Byoung Whi Kim, Daejeon (KR); Mahn Yong Park, Daejeon (KR); Hyun Ho Yoon, Daejeon (KR)

(73) Assignee: MEL, Daejeon (KR)

(21) Appl. No.: 13/384,935

(22) PCT Filed: Jul. 23, 2009
(86) PCT No.: PCT/KR2009/004111

§ 371 Date: Jan. 19, 2012

(30) Foreign Application Priority Data
Jul. 23, 2009 (KR) 10-2009-0067253

(51) Int. Cl. H04B 10/08; H04B 17/00

(52) U.S. Cl. 398/16

(57) ABSTRACT

Provided is an optical communication system including: a remote control device for generating OAM (Operation, Administration, and Maintenance) signal including OAM information for equipment, converting the OAM signals to OAM optical signals, overlaying the OAM optical signals and communication upstream signals transmitted to a Communication Stations device, and controlling the transmission of the overlaid signals to the Communication Stations device; and the Communication Stations device for generating OAM control signals, converting the OAM control signal to OAM optical control signals, overlaying the OAM optical control signals and optical communication downstream signals transmitted to the remote control device, and controlling the transmission of the overlaid control signals to the remote control device.

### TECHNICAL FIELD

The present invention relates to an optical communication system supporting remote operation management, and more particularly, to an optical communication system capable of separating and using an optical signal for a communication signal and an optical signal for an operation, administration, and maintenance (OAM) signal overlaid and transmitted through an optical line at Communication Station device by performing a control to communicate the optical signal for the communication signal and the optical signal for the OAM signal between a remote device and the Communication Station device by an overlaid optical wavelength and performing a control to allow the communication signal and the OAM signal to have different frequency bands.

### Background Art

Various audio, data, broadcast convergence services have recently become a highly marketable industry, such that an optical network has suddenly increased worldwide. Meanwhile, a profit structure due to keen competition among communication service providers and reduction in PSTN telephone subscribers, reduction in leased line subscribers, or the like, has been suddenly reduced. In order to overcome the above problems, global communication service providers have been attempted to remarkably reduce operation management costs by reducing the number of Communication Stations and globalizing another Communication Stations. In order to communicate the another Communication Stations, a transmission distance of the subscriber network needs to be extended. To this end, various types of extending devices are commercialized.

The device for extending the transmission distance positioned on a communication path out of the Communication Stations is generally configured of an active device that requires power and therefore, the another Communication Stations need to manage a state of the active device. The state management of the remote device needs to process a link layer (Layer 2) in the case of an in-band type that is a type of inserting state management information into a packet for a communication signal. Therefore, an overhead structure may be complicated due to the OAM of the remote device and the reliability of the apparatus may be reduced. Meanwhile, an out-of-band OAM information transfer type includes a physical OAM dedicated communication path separate from a data communication path and therefore, a communication infrastructure building cost may be greatly consumed.

A PON has an optical network structure that forms distribution topology having a tree structure by connecting a single optical line terminal (hereinafter, referred to as ‘OLT’) with a plurality of optical network units (hereinafter, referred to as ‘ONU’) by using a passive optical distributor of 1×N. In the recent international telecommunication union-telecommunication section (ITU-T), standardized contents of an asynchronous transfer mode—passive optical network (hereinafter, referred to as “ATM-PON’) system is documented as ITU-T G.982, ITU-T G.983.1, and ITU-T G.983.3. In addition, a gigabit Ethernet based PON (GE-PON) system has been standardized as at IEEE 802.3ah by Institute of Electrical and Electronics Engineers (IEEE).

The PON type is largely divided into a TDM-PON in a time division multiple type and a WDM-PON in a wavelength division multiple type. A PON technology in the time division multiple type is rooted as a currently representative PON technology since global communication service providers have started research for ATM transfer of 155 Mbps in 1995 and have completed a GE-PON (gigabit Ethernet PON) relating standardization work using an IP technology at 2001. The original technology of the WDM-PON (wavelength passive optical network) technology is held in Korea, which provides an independent wavelength to each subscriber to implement a FTTH structure. As compared with the TDM-PON, the WDM-PDN has flexibility much larger than a transfer protocol and a transfer speed.

A WDM based GE-PON extender or a pure GE-PON extender according to the related art does not include a function of monitoring an operation state of an apparatus or includes a function of monitoring an operation state of an apparatus through a separate IP based communication channel.

However, in order to include a separate IP based communication channel in addition to an additional apparatus such as a data transmission channel, a physical connection line, a transmitting and receiving port, a protocol processing process, or the like, are needed. When the out-bound type according to the related art is applied to the GE-PON link extending apparatus, economic efficiency is reduced and the communication service providers should pay the increased operation or maintenance cost of the whole apparatus, due to a need of additional optical links and accessories.

### DISCLOSURE

### Technical Problem

An object of the present invention is to provide an optical communication system supporting remote operation management, and more particularly, to an optical communication system capable of separating and using an optical signal for a communication signal and an optical signal for an operation, administration, and maintenance (OAM) signal overlaid and transmitted through an optical line at Communication Station device by performing a control to communicate the optical signal for the communication signal and the optical signal for the OAM signal between a remote device and the Communication Station device by an overlaid optical wavelength and performing a control to allow the communication signal and the OAM signal to have different frequency bands.

### Technical Solution

In one general aspect, an optical communication system includes: a remote device performing a control to generate an operation, administration, and maintenance (OAM) signal including OAM information on equipment, convert the OAM signal into an OAM signal, and then, transmit the OAM signal to a Communication Station device while overlaying an optical communication upstream signal transmitted to the Communication Station device; and a Communication Station device performing a control to generate an OAM control signal for controlling the remote device, convert the OAM control signal into an OAM optical control signal, and then, transmit the OAM optical control signal to the remote device while overlaying an optical communication downstream signal transmitted to the remote device.

The optical communication upstream signal and the OAM signal and the optical communication downstream signal and the downstream signal and the OAM control signal may be implemented as an overlaying optical wavelength and may be each transmitted through a single optical fiber while overlaying each other.

The upstream signal included in the optical communication upstream signal and the OAM signal may have different frequency bands from each other and the downstream signal included in the optical communication downstream signal and the OAM control signal may have different frequency bands from each other.

The remote device may include: a micro controller unit (MCU) generating the operation, administration, and maintenance (OAM) information on the equipment and processing the OAM signal; a band pass filter (BDF) filtering the frequency band of the OAM signal with a selected frequency band; a light source converting the OAM signal into an OAM signal; a laser diode driver (LDD) driving the light source so as to convert the OAM signal into the OAM signal by inputting the OAM signal that is an electrical signal into the light source; and an optical coupler performing a control to transmit the OAM optical signal input to the optical fiber to an optical line terminal (OLT) while overlaying the optical communication signal.

The remote device may further include: a first optical coupler branching the OAM optical control signal from the optical signal when receiving the optical signal overlaying the optical communication signal and the OAM optical control signal from the optical line terminal (OLT); a photo diode (PD) converting the branched OAM optical control signal into an OAM control signal that is the electrical signal; a transimpedance amplifier (TIA) amplifying output current from the photodiode and converting the amplified current into voltage; and a limiting amplifier (LA) dividing and amplifying a voltage signal output from the band pass filter into logic 1 and logic 0.

The remote device may use a current signal output from a receive optical power monitoring terminal of a receiver optical sub assembly (ROSA) converting the optical signal into the electrical signal when the optical signal transmitted from the optical line terminal (OLT) is terminated at the remote device so as to be converted into the electrical signal and may include the transimpedance amplifier (TIA), the band pass filter (BPF), the limiting amplifier (LA), and the micro controller unit (MCU) other than the optical coupler.

The Communication Station device may be the optical line terminal (OLT), wherein the optical line terminal (OLT) may include: the optical coupler receiving the optical communication signal overlaying the OAM signal through the optical fiber from the remote device and branching the OAM signal from the optical communication signal; the photo diode (PD) converting the branched OAM signal into the OAM signal that is the electrical signal; the transimpedance amplifier amplifying the output current from the photo diode and converting the amplified current into voltage; the band pass filter (BDF) filtering the frequency band of the OAM signal with the selected frequency band; the limiting amplifier (LA) dividing and amplifying a voltage signal output from the band pass filter into logic 1 and logic 0; and the micro controller unit (MCU) controlling the processing of the OAM signal including the OAM information.

The optical line terminal (OLT) may use the current signal output from the receive optical power monitoring terminal of the receiver optical sub assembly (ROSA) when the optical signal transmitted from the remote device is terminated at the remote device so as to be converted into the electrical signal and may include the transimpedance amplifier (TIA), the band pass filter (BPF), the limiting amplifier (LA), and the micro controller unit (MCU) other than the optical coupler.

### Advantageous Effects

According to the optical communication system of the exemplary embodiments of the present invention, the OAM signal between the Communication Station device and the remote device is transmitted through the single optical line while overlaying the communication signal, such that there is a need to add the separate transmission path for transmitting the OAM signal.

Further, according to the optical communication system of the exemplary embodiments of the present invention, the transmission and processing of the OAM signal are performed within the physical layer (PHY) to minimize the additional hardware and software required to include the remote OAM function, thereby securing the minimization of costs and the high reliability.

In addition, the optical communication system of the exemplary embodiment of the present invention, the remote OAM function can be applied to various apparatuses for the extension of the transmission distance and all the types of the active or passive apparatuses disposed on the communication path.

### BRIEF DESCRIPTION OF THE DRAWINGS

FIG. 1 is a diagram showing a configuration of a general passive optical network.

FIG. 2 is a diagram showing a configuration in which an extending apparatus is included in a communication path connecting a Communication Station communication system with a consumer side subscriber terminal.

FIG. 3 is a diagram showing a configuration of a passive optical network including the extending device transmitting and receiving an OAM signal according to the exemplary embodiment of the present invention.

FIG. 4 is a diagram showing in more detail a configuration of the extending device transmitting and receiving the OAM signal according to the exemplary embodiment of the present invention.

FIG. 5 is a diagram showing a configuration of the Communication Station communication system transmitting and receiving the OAM signal according to the exemplary embodiment of the present invention.

FIG. 6 is a diagram showing in more detail a configuration of the Communication Station communication system transmitting and receiving the OAM signal according to the exemplary embodiment of the present invention.

FIG. 7 is a diagram showing an example of colorless optical transmission that may be used to transmit the OAM signal according to the exemplary embodiment of the present invention.

FIG. 8 is a diagram showing an example in which the OAM signal and the communication signal have different frequency bands so as to differentiate the OAM signal from other communication signals according to the exemplary embodiment of the present invention.

FIG. 9 is a diagram showing various examples providing a remote OAM function in a passive optical network (PON) according to the exemplary embodiments of the present invention.

### DETAILED DESCRIPTION OF MAIN ELEMENTS

301: Communication Station communication system

302: Consumer

311, 321, and 331: Extending apparatus

312, 322, and 332: OAM device

323, 332, and 334: Optical coupler

### Best Mode

Hereinafter, exemplary embodiments of the present invention will be described in detail with reference to the accompanying drawings.

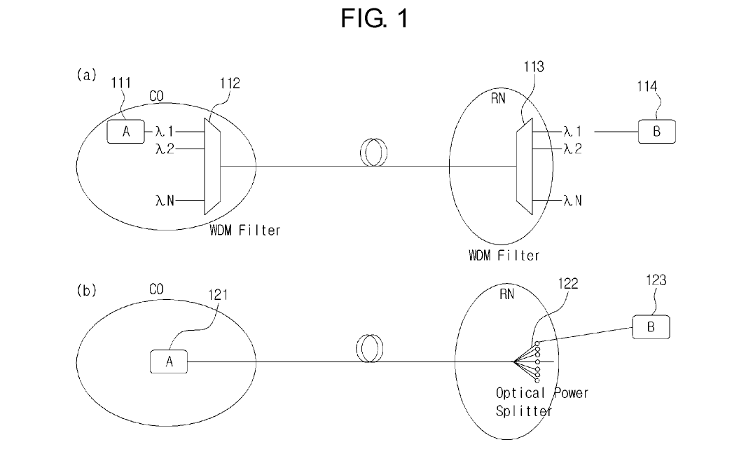

FIG. 1 is a diagram showing a configuration of a general passive optical network.

Generally, a passive optical network (PON) may be divided into a WDM-PON in a wavelength division multiple type and a TDM-PON in a time division multiple type. FIG. 1(a) shows a general configuration of the WDM-PON and FIG. 1(b) shows a general configuration of the TDM-PON.

In FIG. 1(a), the WDM-PON can implement a plurality of communication paths within a single optical fiber by multiplexing a plurality of optical wavelengths and providing each optical wavelength to an independent point-to-point communication path. That is, a first optical signal to an N-th optical signal having a first wavelength to an N-th wavelength transmitted from a communication system A 111 positioned at a Communication Station device are multiplexed by a Communication Station WDM filter 112 and are transmitted to a terminal side WDM filter 113 through a single optical fiber.

The terminal side WDM filter 113 may demultiplex the optical signal received through the single optical fiber into the first optical signal to the N-th optical signal having the first wavelength to the N-th wavelength and transmit the multiplexed first optical signal to N-th optical signal to the corresponding consumer side subscriber terminals B 114, respectively.

In FIG. 1(b), the TDM-PON has a structure of sharing a single feeder optical fiber by transmitting and receiving the optical signal so that a plurality of subscriber terminals B 123 does not temporally overlay one anther. In the case of the TDM-PON, an optical power splitter 122 branching optical power may be positioned in the vicinity of a consumer side subscriber zone.

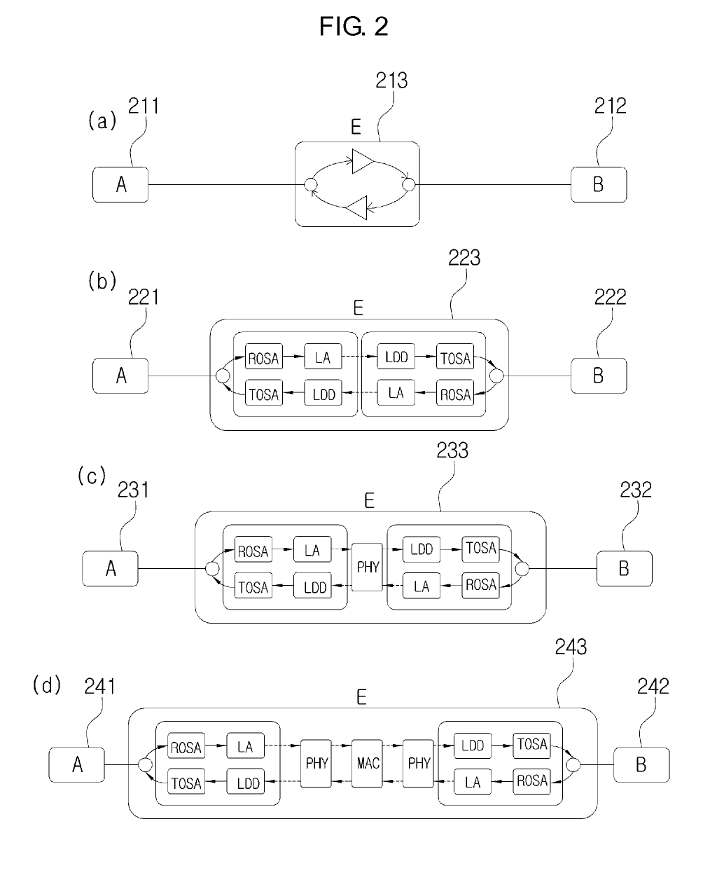

FIG. 2 is a diagram showing a configuration in which an extending apparatus is included in a communication path connecting a Communication Station communication system with a consumer side subscriber terminal.

In order to farther transmit the optical signal, the extending apparatus may be mounted on the communication path connecting a Communication Station communication system A 211 with a consumer side subscriber terminal 212.

FIG. 2(a) shows a configuration of as a physical layer extending apparatus 213 a bidirectional optical amplification apparatus mounted on the communication path that connects the Communication Station communication system A 211 with the consumer side substrate terminal 212. FIG. 2(b) shows as an example of another physical layer extending apparatus 223 an example of relaying a signal by simply converting an optical signal/electrical signal/optical signal (O/E/O) by back-to-back connecting a communication system A 221 with a consumer side subscriber terminal 222.

FIG. 2(c) shows as an example of another physical layer extending apparatus 233 an example of improving quality of a signal relayed by adding a PHY function between a Communication Station communication system A 231 and a consumer side subscriber terminal 232. FIG. 2(d) shows as an example of an extending apparatus 243 including a link layer an example in which an MAC function is further included between a Communication Station communication system A 231 and a consumer side subscriber terminal 232.

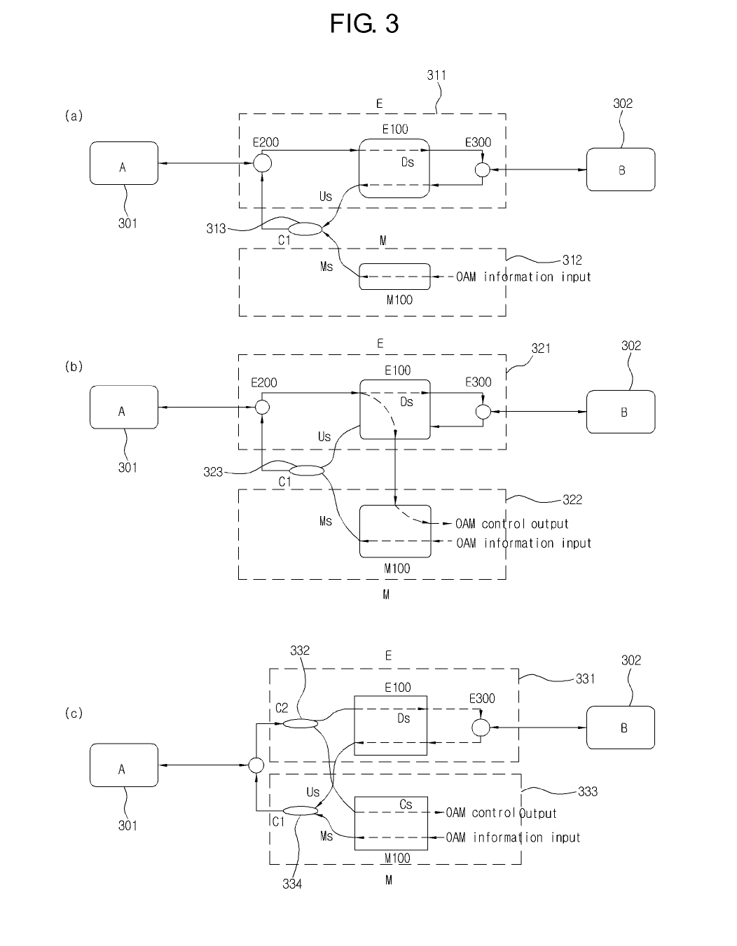

FIG. 3 is a diagram showing a configuration of a passive optical network including the extending apparatus transmitting and receiving the OAM signal according to the exemplary embodiment of the present invention. According to the exemplary embodiment of the present invention, the extending apparatus may be mounted with the OAM device so as to transmit and receive operation, administration, maintenance (OAM) information of an optical module that are included in the extending apparatus. The OAM device may be implemented as a component of the extending apparatus and a separate component mounted adjacent to the extending apparatus.

FIG. 3(a) shows a case in which an OAM signal is transmitted to a Communication Station communication system A 301 while being coupled with an upstream signal (US). The OAM information on an extending apparatus E 311 and an OAM device M 312 is converted into the optical signal and the OAM signal that is an optical signal including the OAM information may be transmitted to the Communication Station communication system A 301 while being coupled with the upstream signal (US) through an optical coupler C1 313.

FIG. 3(b) shows a case in which the Communication Station communication system A 301 transmits the OAM control signal to the extending apparatus E 321 to remotely control the extending apparatus E 321. The OAM control signal transmitted from the Communication Station communication system A 310 is received at a receiving end of the extending apparatus E 321, which is in turn transmitted to an OAM device M 322 through an electrical circuit. The OAM device M 322 may output the OAM control signals for controlling the extending apparatus E 321 and the OAM device M 322.

FIG. 3(c) shows a transfer type of the OAM signal in the case in which the optical signal transmitted from the Communication Station communication system A 301 is terminated at the extending apparatus E 331 so as to be converted into the electrical signal. The optical signal transmitted from the Communication Station communication system A 301 is branched from an optical coupler C2 332, such that a portion of the optical signal is input to a receiver optical sub assembly (ROSA) in an optical receiver of the extending apparatus E 331 and another portion of the optical signal may be input to an optical transceiver of an OAM device M 333.

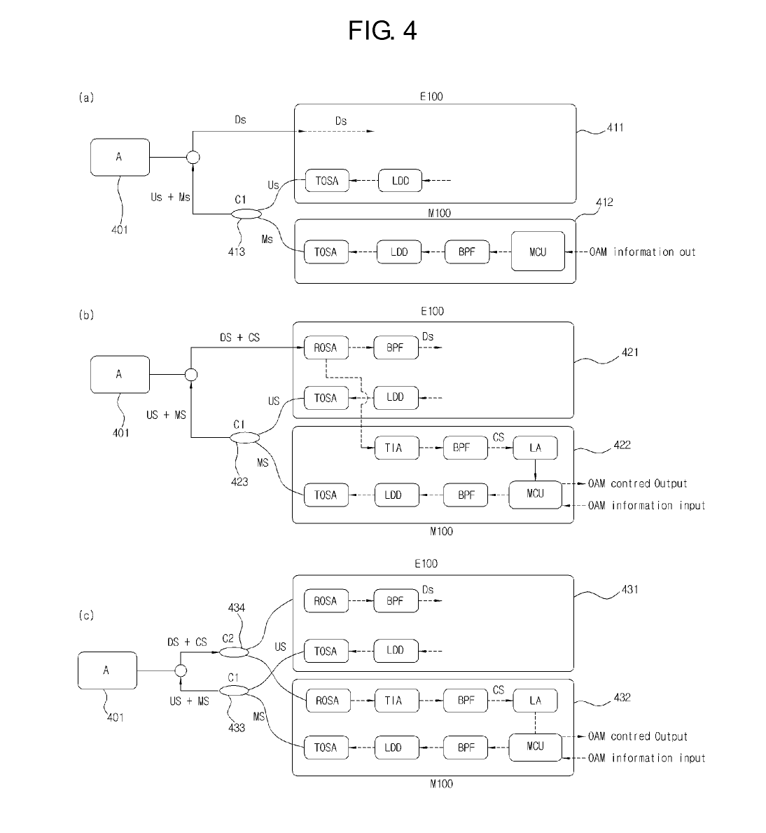

FIG. 4 is a diagram showing in detail a configuration of the extending apparatus transmitting and receiving the OAM signal according to the exemplary embodiment of the present invention.

In FIG. 4(a), the OAM information that is status information of an extending apparatus E 411 and an OAM device M 412 is processed as a transmission signal through a micro controller unit (MCU) of the OAM device 412, such that a frequency bandwidth of the corresponding transmission signal may be filtered through a band pass filter (BPF) and the transmission signal may be converted into a current signal through a laser diode driver (LDD) and may be converted into an optical signal through a transceiver optical sub assembly (TOSA). The OAM signal transmitted from the TOSA may be transmitted to the Communication Station communication system A 401 while being coupled with the upstream signal (US) through the optical coupler C1 413.

In FIG. 4(b), the optical signal transmitted from the Communication Station communication system A 401 is converted into the electrical signal through the receiver optical sub assembly (ROSA) in the optical receiver of the extending apparatus E 421 and a portion of the converted electrical signal is separated from a downstream signal through the band pass filter (BPF) and is output so as to be transmitted to the consumer side subscriber terminal.

In addition, another portion of the converted electrical signal is input to the OAM device M 422 and is then converted into a voltage signal amplified in a trans-impedance amplifier (TIA) and the OAM control signal is separated and filtered from the downstream signal through the band pass filter (BPF), is recovered to a digital signal for OAM control through a limiting amplifier (LA) and is input to a micro controller unit (MCU). The micro controller unit (MCU) transmits the OAM control signal for the extending apparatus E 421 and the OAM device M 422.

Further, the OAM information that is status information of the extending device E 421 and the OAM device M 422 is processed as the transmission signal through the micro controller unit (MCU) of the OAM device 422, such that the frequency bandwidth of the corresponding transmission signal may be filtered through a band pass filter (BPF) and the transmission signal may be converted into a current signal through the laser diode driver (LDD) and may be converted into the optical signal through the transceiver optical sub assembly (TOSA). The OAM signal transmitted from the TOSA may be transmitted to the Communication Station communication system A 401 while being coupled with the upstream signal (US) through the optical coupler C1 423.

In FIG. 4(c), the optical signal transmitted from the Communication Station communication system A 401 is branched from the optical coupler C2 434 and therefore, a portion of the optical signal is input to the receiver optical sub assembly (ROSA) in the optical receiver of the extending apparatus E 431. A portion of the input optical signal is converted into the electrical signal through the receiver optical sub assembly (ROSA) in the optical receiver of the extending device E 431 and a portion of the converted electrical signal is separated from the downstream signal through the band pass filter (BPF) and is output so as to be transmitted to the consumer side subscriber terminal.

In addition, another portion of the optical signal is input to the receiver optical sub assembly (ROSA) in a receiver of the OAM device M 432 so as to be converted into the electrical signal and is converted into the voltage signal amplified in the trans-impedance amplifier (TIA) and the OAM control signal is separated and filtered from the downstream signal through the band pass filter (BPF), is recovered to the digital signal for OAM control through the limiting amplifier (LA), and is input to the micro controller unit (MCU). The micro controller unit (MCU) transmits the OAM control signal for the extending device E 431 and the OAM device M 432.

Further, the OAM information that is status information of the extending device E 431 and the OAM device M 432 is processed as the transmission signal through the micro controller unit (MCU) of the OAM device 432, such that the frequency bandwidth of the corresponding transmission signal may be filtered through a band pass filter (BPF) and the transmission signal may be converted into a current signal through the laser diode driver (LDD) and be converted into the optical signal through the transceiver optical sub assembly (TOSA). The OAM signal transmitted from the TOSA may be transmitted to the Communication Station communication system A 401 while being coupled with the upstream signal (US) through the optical coupler C1 433.

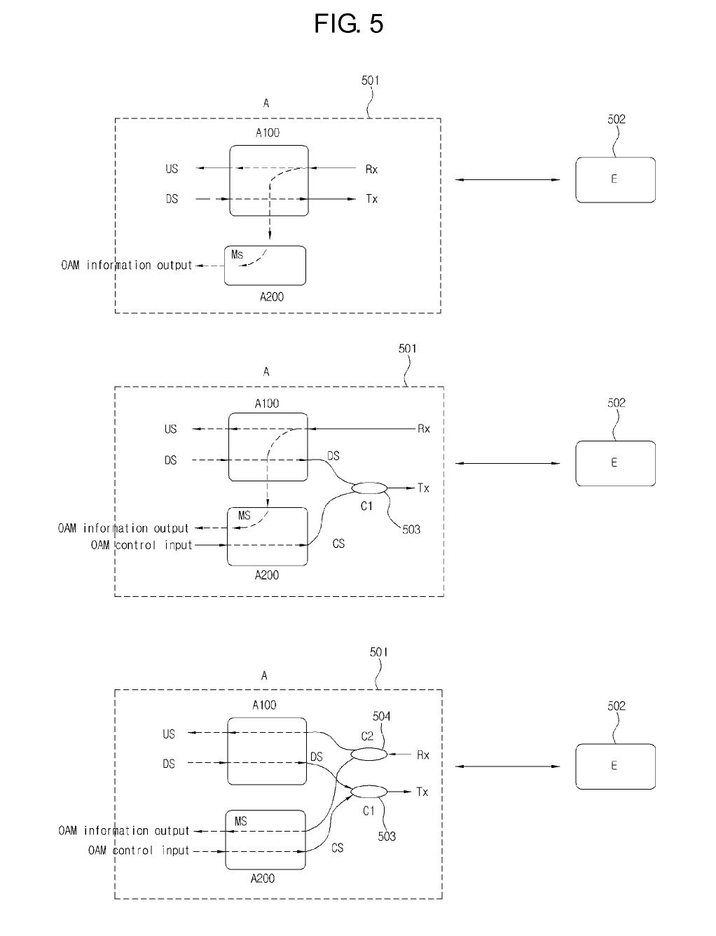

FIG. 5 is a diagram showing a configuration of the Communication Station communication system transmitting and receiving the OAM signal according to the exemplary embodiment of the present invention.

In FIG. 5(a), the optical signal transmitted from the extending apparatus E 502 is converted and output into the electrical signal in the ROSA A100 in the optical receiver of the Communication Station communication system A 501. A portion of the output electrical signal is recovered to the upstream data signal and another portion of the output electrical signal is input to an OAM unit A200 of a Communication Station communication system A 501 and is recovered to the OAM data signal.

In FIG. 5(b), the OAM control signal for controlling the extending apparatus E 502 and the OAM device M is converted into the optical signal in the OAM unit A200 of the Communication Station communication system A 501 and is coupled with the downstream signal DS in the optical coupler C1 503 and is transmitted to the extending apparatus E 502. In addition, the upstream optical signal transmitted from the extending apparatus E 502 is converted into the electrical signal in the ROSA A100 in the optical receiver of the Communication Station communication system A 501. A portion of the electrical signal is recovered to the upstream data signal and another portion of the electrical signal is input to the OAM unit A200 of a Communication Station communication system A 501 and is recovered to the OAM data signal.

In FIG. 5(c), the upstream optical signal transmitted from the extending apparatus E 502 is branched from the optical coupler C2 504 such that a portion of the upstream optical signal is input to the ROSA A100 in the optical receiver of the Communication Station communication system A 501 and another portion of the upstream optical signal is input to the OAM unit A 200 of the Communication Station communication system A 501. The upstream optical signal input to the ROSA A100 in the optical receiver of the Communication Station communication system A 501 is converted into the electrical signal. Another portion of the upstream optical signal input to the OAM unit A200 of the Communication Station communication system A 501 is input to the OAM unit A 200 of the Communication Station communication system A 501 and is recovered to the OAM data signal.

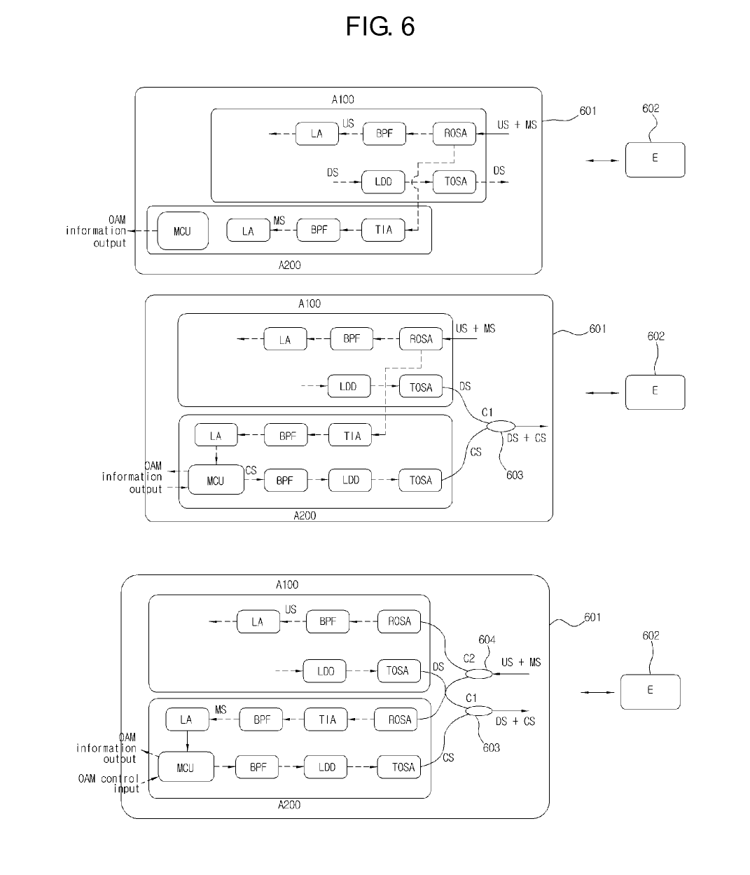

FIG. 6 is a diagram showing in more detail a configuration of the Communication Station communication system transmitting and receiving the OAM signal according to the exemplary embodiment of the present invention.

In FIG. 6(a), the optical signal transmitted from the extending apparatus E 602 is converted and output into the electrical signal in the ROSA in the optical receiver A100 of a Communication Stations communication system A 601. A portion of the electrical signal is returned to the upstream digital signal via the band pass filter (BPF) and the limiting amplifier (LA). Another portion of the electrical signal is input to the OAM unit A200 of the Communication Stations communication system A 601 and is converted into the amplified voltage signal through the transimpedance amplifier and the OAM information signals is separated and filtered from the communication signal through the band pass filter BPF, is recovered to the OAM information digital signal through the limiting amplifier, and is input to the micro controller unit (MCU). The micro controller unit (MCU) may output the OAM information on the extending apparatus E 602 and the OAM device M through the OAM information digital signal.

In FIG. 6(b), the OAM control signal for controlling the extending apparatus E 602 and the OAM device M is processed as the transmission signal through the micro controller unit (MCU) of the OAM unit A200 of the Communication Stations communication system A 601, such that the corresponding frequency band of the OAM control signal is filtered through the band pass filter (BPF) and the OAM control signal is converted into the current signal and is converted into the optical signal through the transceiver optical sub assembly (TOSA). The OAM control optical signal output through the conversion process may be coupled with the downstream signal DS through the optical coupler C1 603 so as to be transmitted to the extending apparatus E602.

In FIG. 6(c), the optical signal transmitted from the extending apparatus E 602 is branched from the optical coupler C2 604 such that a portion of the optical signal is input to the ROSA in the optical receiver A100 of the Communication Stations communication system A 601 and another portion of the optical signal is input the ROSA in the optical receiver A100 of the OAM unit A 200. The following may be recovered to the upstream signal and the OAM information, respectively, like the procedure described through (b).

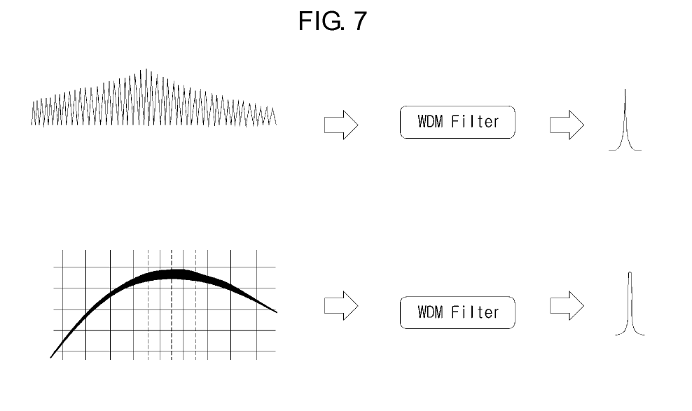

FIG. 7 is a diagram showing an example of colorless optical transmission that may be used to transmit the OAM signal according to the exemplary embodiment of the present invention.

The colorless means characteristics operated regardless of the optical wavelength in which an optical transmitter is used for communication. FIG. 7(a) shows a case in which a multi mode light source such as FP LD is used. In the case of several wavelengths for communication like the WDM-PON, the optical wavelength forming the specific communication path is determined by the WDM filter disposed on the communication path. The multi mode of the FP LD of which the specific mode (wavelength) is filtered by the WDM filter may be transmitted to a receiving side. Therefore, the same light source can be used regardless of the used optical wavelength and the used optical wavelength is divided by the WDM filter, such that the colorless optical transmitter may be implemented. FIG. 7(b) shows an example using a broadband light source (BLS) like ROSA. The specific wavelength of the wide band light is filtered by the WDM filter, thereby providing the colorless optical transmitting function like the case of the FP LD.

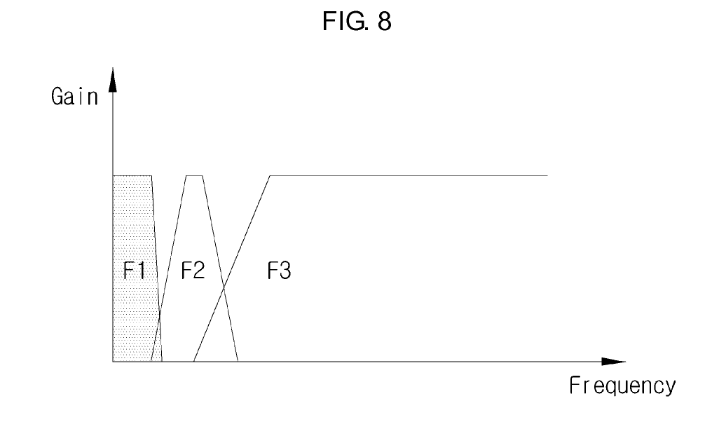

FIG. 8 is a diagram showing an example in which the OAM signal and the communication signal have different frequency bands so as to differentiate the OAM signal from other communication signals according to the exemplary embodiment of the present invention. As shown in FIG. 8, the OAM signal uses a frequency band F1 and may differentiate a frequency band F2 and a frequency band F3 of other communication signals.

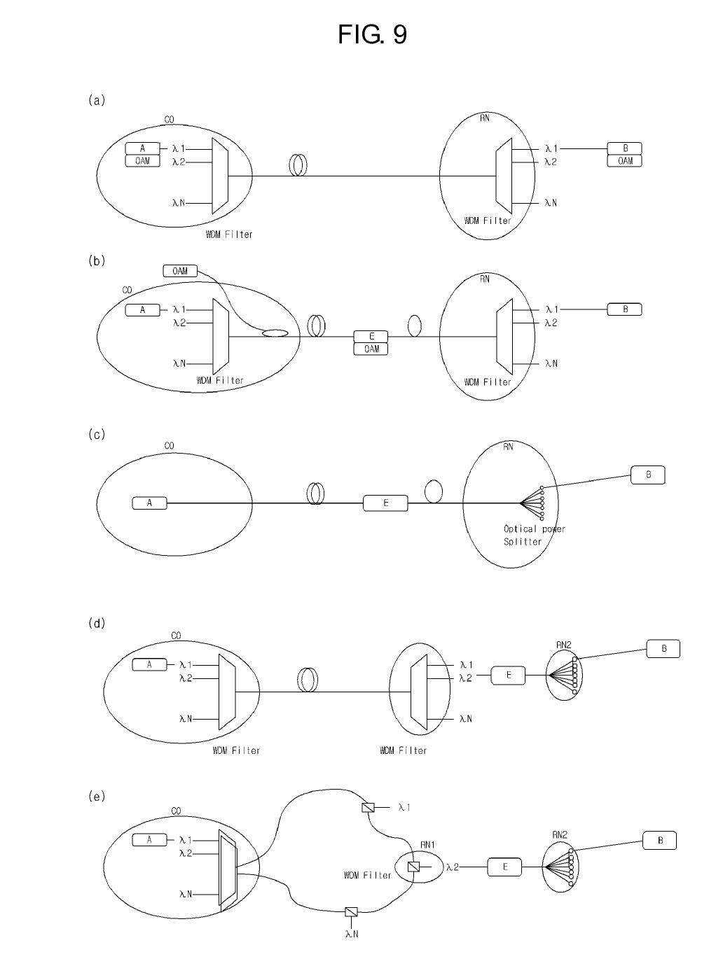

FIG. 9 is a diagram showing various examples providing a remote OAM function in a passive optical network (PON) according to the exemplary embodiments of the present invention.

(a) shows a case in which the remote OAM function according to the exemplary embodiment of the present invention is applied to the WDM-PON. In this case, the independent OAM function may be provided for each optical wavelength. (b) shows a case in which the remote OAM function according to the exemplary embodiment of the present invention is applied to the WDM-PON. The difference in the case (a) may provide the integrated OAM function for all the optical wavelengths.

(c) shows the case in which the OAM function according to the present invention present invention is applied and (d) shows the case in which the remote OAM function according to the present invention is applied to the WDM-TDM-PON. In this case, the independent OAM function may be provided for each optical wavelength. (e) shows a case in which the remote OAM function according to the exemplary embodiment of the present invention is applied to the WDM-TDM-PON. In this case, the independent OAM function may be provided for each optical wavelength.

As described above, according to the optical communication system of the present invention, the OAM signal between the Communication Stations device and the remote device is transmitted through the single optical line while overlaying the communication signal, such that there is a need to add the separate transmission path for transmitting the OAM signal. Further, the transmission and processing of the OAM signal are performed within the physical layer (PHY) to minimize the additional hardware and software required to include the remote OAM function, thereby securing the minimization of costs and the high reliability. In addition, the optical communication system of the exemplary embodiment of the present invention, can be applied to give the remote OAM function to various apparatuses for the extension of the transmission distance and all the types of the active or passive apparatuses disposed on the communication path.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

1.-8. (canceled)

9. An optical communication system, comprising:
a remote device performing a control to generate an operation, administration, and maintenance (OAM) signal including OAM information on the remote device, convert the OAM signal into an OAM maintenance signal by using a separate light source, and then, transmit the OAM maintenance signal to a communication station device while optically overlaying an optical communication upstream signal transmitted to the communication station device within the same optical wavelength; and
a communication station device generating an OAM control signal for controlling the remote device, converting the OAM control signal into an OAM optical control signal by using the separate light source, and then, transmitting the OAM optical control signal to the remote device while optically overlaying an optical communication downstream signal transmitted to the remote device within the same optical wavelength.

10. The optical communication system of claim 9, wherein the upstream signal included in the optical communication upstream signal and the OAM signal have different electrical frequency bands from each other and the downstream signal included in the optical communication downstream signal and the OAM control signal have different electrical frequency bands from each other.

11. The optical communication system of claim 9, wherein the remote device includes:
a micro controller unit (MCU) generating the operation, administration, and maintenance (OAM) information on the corresponding remote device and processing the OAM signal including the OAM information;
a band pass filter (BDF) filtering the frequency band of the OAM signal with a selected frequency band;
a light source converting the OAM signal into an OAM maintenance signal;
a laser diode driver (LDD) driving the light source so as to convert the OAM signal into the OAM maintenance signal by inputting the OAM signal that is an electrical signal into the light source; and
an optical coupler performing a control to transmit the OAM optical signal input to an optical fiber to an optical line terminal (OLT) while overlaying the optical communication signal.

12. The optical communication system of claim 11, wherein the remote device further includes:
a first optical coupler branching the OAM optical control signal from the optical signal when receiving the optical signal overlaying the optical communication signal and the OAM optical control signal from the optical line terminal (OLT);
a photo diode (PD) converting the branched OAM optical control signal into an OAM control signal that is the electrical signal;
a current-voltage converting device converting output current from the photo diode into voltage; and
a limiting amplifier (LA) dividing and amplifying a voltage signal output from the band pass filter into logic 1 and logic 0.

13. The optical communication system of claim 11, wherein the remote device uses a current signal output from a receive optical power monitoring terminal of a receiver optical sub assembly (ROSA) converting the optical signal into the electrical signal when the optical signal transmitted from the optical line terminal (OLT) is terminated at the remote device so as to be converted into the electrical signal and includes the current-voltage converting device, the band pass filter (BPF), the limiting amplifier (LA), and the micro controller unit (MCU) other than the optical coupler.

14. The optical communication system of claim 11, wherein the communication station device is the optical line terminal (OLT), the optical line terminal (OLT) including:
the optical coupler receiving the optical communication signal overlaying the OAM maintenance signal through the optical fiber from the remote device and branching the OAM maintenance signal from the optical communication signal;
the photo diode (PD) converting the branched OAM maintenance signal into the OAM signal that is the electrical signal;
the current-voltage converting device converting the output current from the photo diode into voltage;
the band pass filter (BDF) filtering the frequency band of the OAM signal with the selected frequency band;
the limiting amplifier (LA) dividing and amplifying a voltage signal output from the band pass filter into logic 1 and logic 0; and
the micro controller unit (MCU) controlling the processing of the OAM signal including the OAM information.

15. The optical communication system of claim 14, wherein the optical line terminal (OLT) uses the current signal output from the receive optical power monitoring terminal of the receiver optical sub assembly (ROSA) when the optical signal transmitted from the remote device is terminated at the remote device so as to be converted into the electrical signal and includes the current-voltage converting device, the band pass filter (BPF), the limiting amplifier (LA), and the micro controller unit (MCU) other than the optical coupler.
